(19) United States
(12) Patent Application Publication
(10) Pub. No.: US 2014/0062073 A1
(43) Pub. Date: Mar. 6, 2014

(54) ALVEOLAR CAGE

(71) Applicant: Sonia Regina de Castro, (US)

(72) Inventor: Sonia Regina De Castro, Sao Pedro de Alcantara (BR)

(73) Assignee: Sonia Regina de Castro, Sao Pedro de Alcantara, (SC) (BR)

(21) Appl. No.: 13/261,686

(22) PCT Filed: Dec. 29, 2010
(86) PCT No.: PCT/BR2010/000447

§ 371 Date: Nov. 13, 2013

(30) Foreign Application Priority Data
Dec. 29, 2009 (BR) PI09058656
Apr. 28, 2010 (BR) PI10012834

(51) Int. Cl. B60R 21/13

(52) U.S. Cl. CPC B60R 21/13
USPC 280/756

(57) ABSTRACT

It is characterized by a cage structure (4, 5, 6, 7, 8, 9, 10, 11, 14) fitted with safety belts that can be simply attached or rested on supports (1, 2, 3, 15) and fixed onto motorcycles, moto scooters, tricycles or ATVs, and which can be ejected through impact of any eventual accidents. It is composed of modules (4, 6, 8, 10, 11, 12, 14) that have bends or sharp curves, which are joined using two plates (5, 9), one on either side, which can be molded around the curves and fastened onto one another, without the need for drilling holes in the tubes, thus maintaining their overall strength. The top module (8) and the side shields (19) can have a hood made of a malleable material, with covered Styrofoam plates on the inside, reinforced with strips made of rubber, plastic or a similar material.

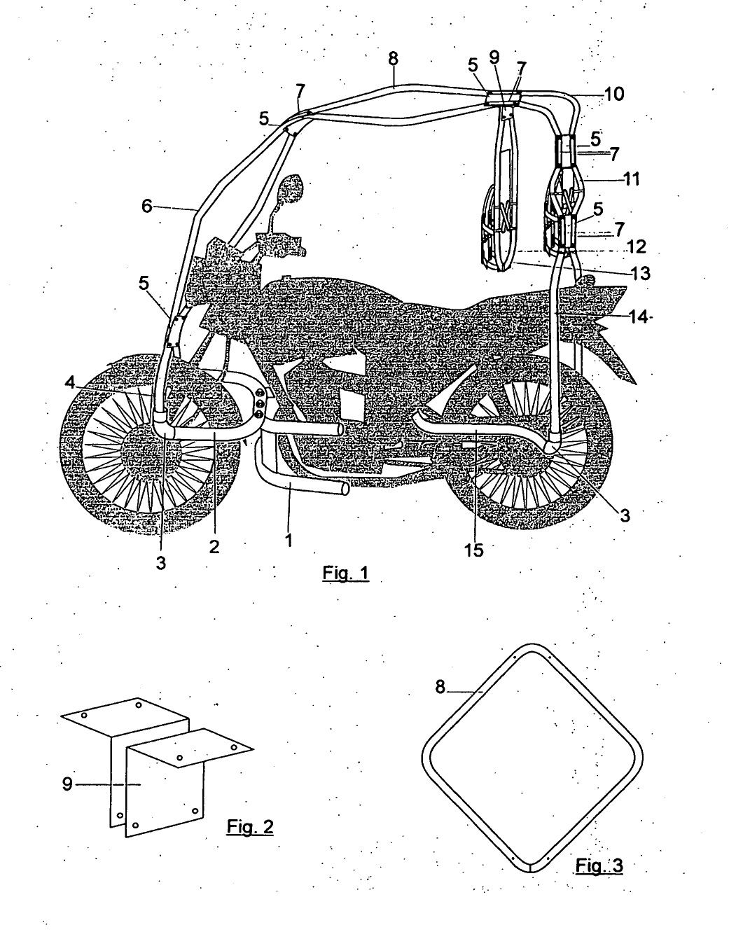

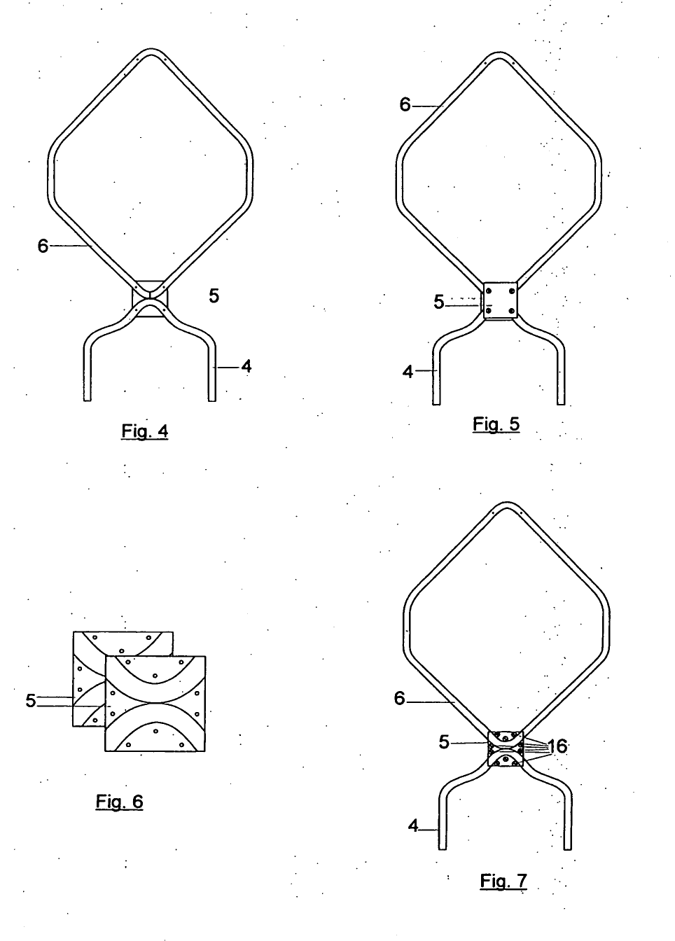

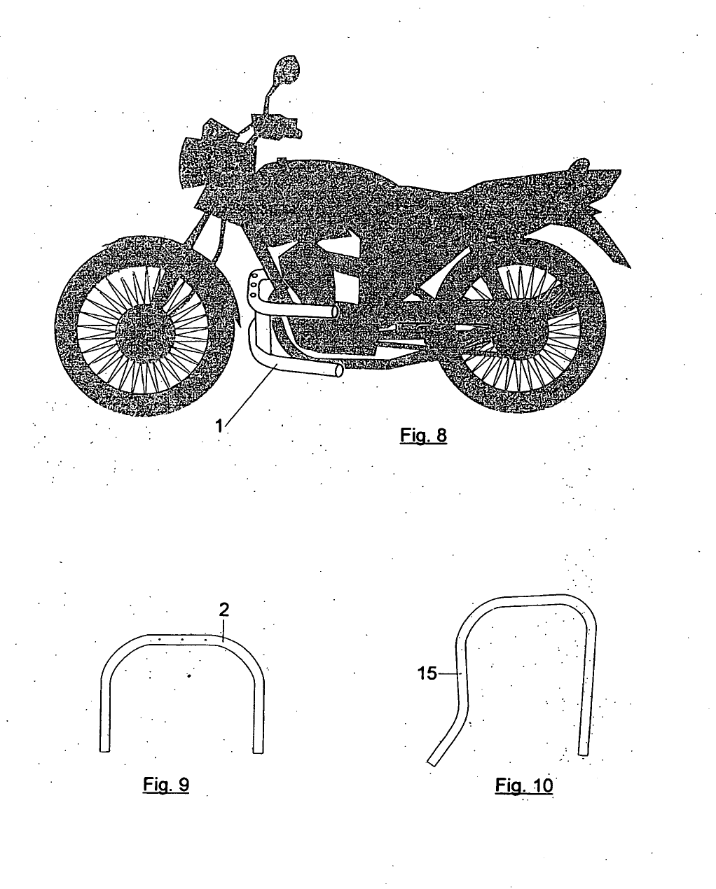

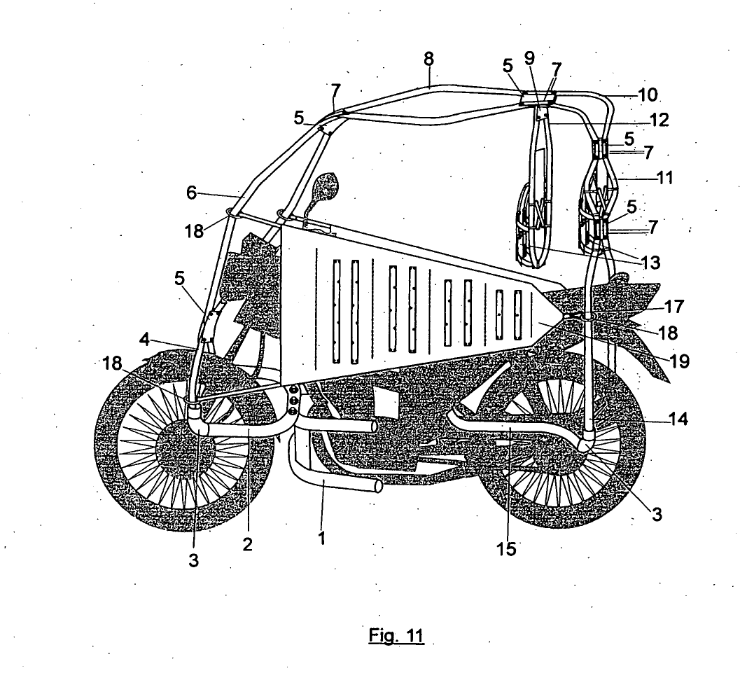

The Alveolar Cage is characterized by a structure composed of modules made of metal tubes with bends or sharp curves, which are attached to one another via two plates, one on each side, by the curves, and which can be molded into the shape of the curves and attached to the areas that contour the tubes without the need for drilling into them; this structure can be fixed around motorcycles, tricycles, and ATVs or similar vehicles, serving as a support for safety belts and jackets that can simply be rested on the supports—which can be of the “engine guard” type—and can eventually be disconnected and even ejected through impact resulting from an any possible collision; it can also have pliable shields for the protection of motorcyclists' knees and legs and can be padded and/or reinforced with rubber covering or similar.

### PRIOR ART

Motorcycles equipped with safety belts keep their passengers attached to the vehicle. But there are cases of accidents in which the vehicles were seriously damaged and the motorcyclists escaped unscathed or with light injuries, because of having been ejected away, which lessens the impact.

Fastening the cage onto ready-made vehicles may also damage the original structure.

Motorcycles equipped with safety belts are open on the sides, offering no leg protection.

On a previous request, I introduced plates that operate as supports for safety jackets. These plates were fastened onto side tubes using strips—a malleable material which created instability. The system also required the installation of lateral tubes, parallel to the passengers.

These structures or similar cages have joints with couplings or welds. Such couplings are vulnerable to strong impact.

### EXPOSITION OF THE INVENTION

It consists of structures composed of modules that have bends or sharp curves, which are joined together with the assistance of two plates, one on each side of the tubes, in a similar format to that of a sandwich. The plates can be shaped around the curves, and come into contact with one another at some points where holes are drilled for fastening, using a means that avoids drilling holes in the tubes themselves, thus preserving their strength.

These modules can be in different formats, and can be joined at several points, and more that two modules can be joined at the same point. In this way, it is then possible to assemble structures in several formats.

The plates can also be bent to attach modules in different directions. In this way, a module that serves as support for the driver's jacket is fastened to a cage installed around the motorcycle.

This structure can simply be rested or inserted into supports installed in the motorcycle, so that it can be disconnected or even ejected away through impact from any eventual accident. This reduces the risk of damage to the original structure of the vehicle and eliminates the possibility of aggravating risks to the motorcyclists.

The supports installed on the motorcycles can be in a similar shape to engine guards, the effects of which on the structure of motorcycles are well known, and represent no risk whatsoever.

They are sold on the market as engine guards to be fitted at the front of the vehicle. A curved tube, with its ends turned towards the front of the vehicle, is bolted onto the engine guard. Engine guards with this format can also be developed.

In order to support the cage at the rear, a part made from tubing was developed, which is laid across the gearing, from one side of the vehicle to the other. This is fastened using clamps in order to avoid drilling or welding.

The plates with safety jackets onto modules connected to the upper and rear part of the cage structure, remaining stable.

Various other pieces of equipment can be attached to the cage: an infant seat to improve safety whilst transporting children; a malleable material shield—which requires little space, especially when parking—, with inner padding and/or reinforced with strips of rubber material on the inside; coverings and waterproof hoods for weather protection.

### DESCRIPTION OF DRAWINGS

DRAWING 1: View of a motorcycle with a cage attached to the engine guard and with safety jackets fastened to plates;

DRAWING 2: Enlarged view of the parts that support the module onto which the driver's safety jacket is fastened;

DRAWING 3: View of the module located at the upper part of the vehicle;

DRAWING 4: View of the two modules located at the front of the cage, with bends resting on a plate;

DRAWING 5: View of the two modules located at the front of the cage, with a plate on either side of their bends;

DRAWING 6: View of the two plates molded around the curves of the metal tubes;

DRAWING 7: View of the two modules located at the front of the cage, with plates molded around their curves and fastened with bolts;

DRAWING 8: View of a motorcycle with an engine guard;

DRAWING 9: View of the cage's frontal support;

DRAWING 10: View of the cage's rear support;

DRAWING 11: View of motorcycle with a cage attached to the engine guard, with safety jackets fastened to plates and a shield;

The best way to manufacture this invention

The tubes are bent to make each module. Drawings 4, 5 and 7 show the modules located at the front part of the vehicle; the lower one (4), the ends of which rest on the support (3) and the one by the handle bar (6). Drawing 3 shows the module located at the top part (8), the shape of which is the same as the one behind the passenger (11), only differing in size. The curved module at the top rear part (10) also has the same shape, only bent. Likewise, the module at the lower rear part (14) has the same shape as the one at the lower front part (4), with longer ends and a difference of 8 cm between the two sides.

Drawings 4, 5 and 7 also illustrate the way the modules are attached to one another. Drawings 4 and 5, represent straight plates with two holes at each side corresponding to the holes drilled in the curves, through which they are fastened. Reinforcing bars (7) must also be fastened onto one of the sides.

In drawings 6 and 7, it is possible to see that the plates (5) are molded into the shape of the curves and the bolts (16) are only fastened at the areas onto which the plates (5) rest, therefore eliminating the need for holes in the tubes.

The module (13) onto which the driver's jacket (12) is fastened is set between the two top modules (8 and 10). On each side of the attachment curve of this module (13), bent plates (9) are placed, according to drawing 2. They are bolted onto one another and onto the plate (5) located on the curves of the top modules (8 and 10).

A waterproof fabric can be fitted onto the top module (8) by means of Velcro, press-studs or similar, enabling removal.

The frontal support (2) is made from a tube with two identical curves as in drawing 9. This is bolted onto the engine guard (1). An engine guard (1) with its top part facing towards the front of the vehicle can also be developed.

The rear support (15) is made from a bent tube, as in drawing 10. This is laid across the gearing, fitted around the vehicle and fastened with clamps.

Curves (3) are welded onto the ends of the frontal support (2). A small piece of tube is welded onto the other end of these curves, with a diameter suitable for fitting the front lower module (4).

The curves of the rear support (15) must be bolted together, at least on the side that is laid across the gearing. Each curve end is welded onto a small piece of tube of a diameter that fits into the support (15) and into the lower rear module (14).

The shield (19) is made from a resistant and malleable double-sided material. Styrofoam plates covered in a malleable material, glued and reinforced with pins on the sides, are placed on the inside. A layer of foam may also be used on these plates. Rubber strips fastened with rivets are attached to the outer side of the shields (19).

In order to attach the shields (19), hoops (18) are welded onto the two front modules (4 and 6) and onto the lower rear module (14). The two front hoops (18) are fixed using nylon clamps and at the rear, using a spring safety hook (17).

Possible Industrial Applications

This invention can be manufactured to fit any type of motorcycle, motor scooter, and ATVs already in use on the roads; it is adaptable to a diverse range of vehicle models of this kind already in existence on the marketplace, in addition to its use in the assembly of new vehicles. The modules fitting system can also be applied to other diverse structures.

1. The cage is fixed to the vehicle by welding or by any other means which may damage the structure of vehicle and prevents any possible ejection. Characterized by a cage (4,5,6,7,8,10,11,14) made of metal tubes or any similar structure which is only fit or rested on any supports (1, 2, 3, 15), which may be a pro-guards engine (1), fixed on motorcycles, moto scooters, tricycles and ATVs or similar,

2. (canceled)

3. Motorcycles, scooters and the similar have open sides, without any protection for the rider's knees and legs, not even the ones with safety belts offer this kind of protection; as they take restricted space and have fragile structures on which it is impossible to install previously available doors. Wherein the improvement comprises of protection on the sides—at the height of the legs—and of the combination of compact and flexible materials on small doors (19), which may made of double malleable material, contain polystyrene and foam plates or similar in the inside and straps made of metal, plastic, rubber, or similar, on the outside;

4. (canceled)

5. The tubular structures are made of pieces of tubes with straight or slightly bent ends, which represent a risk in case of a deformation, they are fixed on their ends with the use of diameters that fit in, or by connecting pieces that are completely rounded, or by welding. The improvement consists of modules (6,8,10.11) of pieces of tubes with bent ends on the inside and they may even touch one another, which are connected by two plates (5)—one at either side, by the curves—fixed with rivets, bolts (16) or similar, which contour of the tubes; the plates (5) can be molded in the tubes or in the curves; this structure may be installed around motorcycles, moto scooters, tricycles, ATVs or similar vehicles.

6. (canceled)
